(19) United States
(12) Patent Application Publication
(10) Pub. No.: US 2023/0120023 A1
(43) Pub. Date: Apr. 20, 2023

(54) Crowdfunding Systems and Methods

(71) Applicant: BD Labs, LLC, Madison, MS (US)

(72) Inventors: Ben Hubbard, Brandon, MS (US); Douglas Tucker, Madison, MS (US)

(73) Assignee: BD Labs, LLC, Madison, MS (US)

(21) Appl. No.: 17/501,154

(22) Filed: Oct. 14, 2021

(51) Int. Cl. G06Q 30/02

(52) U.S. Cl. CPC G06Q 30/0279

(57) ABSTRACT

A system that has one or more display devices that display graphical user interfaces (GUI) to a user. Further, the system has a processor communicatively coupled to the one or more display devices via a network, the processor receives data from the GUIs indicative of a goal and a decision maker from an individual, the decision maker having the capacity to obtain the goal, the processor receives pledges from a plurality of users that desire to support the goal, and the processor awards the decision maker the pledges if the goal is met.

### BACKGROUND

Previously, when an entity desired to fund something, be it a project, a company, or anything that requires capital to start, there were ways to raise money. The entity could take on debt from a loan. Further, the entity could raise money from friends, family members, and angel venture capital investors.

In the late 2000s, crowdfunding became a popular means of funding a project, a company, or anything that required capital to start. In this regard, crowdfunding is a method to raise money from many people. Large groups of people pool together small individual investments to provide the capital needed to get a company or project off the ground. Individuals, charities, or companies can create a crowdfunding campaign for specific causes, and anyone can contribute.

There are a variety of types of crowdfunding. For example, there is securities-based crowdfunding, which provides opportunities for people to invest in private companies. There is donation-based crowdfunding, which is when someone donates to a specific cause or charity, e.g., GoFundMe. Further types include reward-based crowdfunding, peer-to-peer lending, real estate crowdfunding, and human capital crowdfunding.

### DESCRIPTION OF DRAWINGS

One may better understand the present disclosure by referencing the following drawings. The elements of the drawings are not necessarily to scale relative to each other, emphasis instead placed upon clearly illustrating the principles of the present disclosure. Furthermore, like reference numerals designate corresponding parts throughout the views.

FIG. 1 is a block diagram of an exemplary crowdfunding system in accordance with an embodiment of the present disclosure.

FIG. 2 is a block diagram of an exemplary crowdfunding computing device as shown in FIG. 1 in accordance with an embodiment of the present disclosure.

FIG. 3 is a block diagram of an exemplary handheld computing device as shown in FIG. 1 in accordance with an embodiment of the present disclosure.

FIG. 4 is a block diagram of an exemplary crowdfunding server as shown in FIG. 1 in accordance with an embodiment of the present disclosure.

FIG. 5 is an exemplary registration and login graphical user interface (GUI) implemented on the computing device and/or the handheld device as shown in FIG. 1.

FIG. 6 is an exemplary main GUI implemented on the computing device and/or the handheld device as shown in FIG. 1.

FIG. 7 is an exemplary entity and/or individual push page GUI implemented on the computing device and/or the handheld device as shown in FIG. 1.

FIG. 8 is an exemplary define push GUI implemented on the computing device and/or the handheld device as shown in FIG. 1.

FIG. 9 is an exemplary goal GUI implemented on the computing device and/or the handheld device as shown in FIG. 1.

FIG. 10 is an exemplary push story GUI implemented on the computing device and/or the handheld device as shown in FIG. 1.

FIG. 11 is an exemplary success GUI implemented on the computing device and/or the handheld device as shown in FIG. 1.

FIG. 12 is an exemplary preview push GUI implemented on the computing device and/or the handheld device as shown in FIG. 1.

FIG. 13 is an exemplary administrative GUI implemented on the crowdfunding server as shown in FIG. 1.

FIG. 14 is an exemplary goal met GUI implemented on the computing device and/or the handheld device as shown in FIG. 1.

FIG. 15 is an exemplary flowchart depicting exemplary architecture and functionality of the system as shown in FIG. 1.

### DETAILED DESCRIPTION

The present disclosure builds upon the idea of donation or reward based crowdfunding and utilizes it to facilitate ideas becoming outcomes. The system of the present disclosure allows like-minded individuals to all contribute resources toward influencing a decision maker in having an action occur that the crowd finds desirable. In this way people can have impact that is beyond their normal financial and social sphere of influence.

The present disclosure describes crowdfunding systems. In particular, the crowdfunding systems of the present disclosure comprise distinct types of input devices, e.g., a computing device, a cellular device, etc. The input devices are communicatively coupled to a server device via a network.

The input devices display a graphical user interface (GUI) that posts a particular decision that requires action on the part of a decision maker. For example, the decision may be a professional athlete signing a contract with a new team. Note that the professional athlete is the decision maker. If a user of an input device desires the professional athlete to sign with the new team, the user may contribute money in support of the decision to contract with the new team.

If the decision maker decides to take conclusive action on the decision posted, i.e., sign with the new team, the decision maker, i.e., the pro athlete, receives the money contributed by the plurality of users or receives a pledge of money to be contributed by the users. If the decision maker decides not to act on the decision posted, the Crowdfunding Entity (a company) returns money contributed by the users to the users or does not collect the money pledged by the users.

In one embodiment, the crowdfunding system of the present disclosure is designed to influence or even create an outcome. For example, a city may be disputing about where to locate a new stadium for a local college football team. In the present decision, the users may contribute money to influence where to build the stadium.

In such a scenario, users may contribute money for locating the stadium at a particular location. Here, the decision maker is the city council. If money contributed by the users for the location at which the city council decides to locate the stadium, the city council shall receive the money pledged or contributed by the users. If not, the Crowdfunding Entity shall return money to the users who contributed money, or not collect the money pledged by the users.

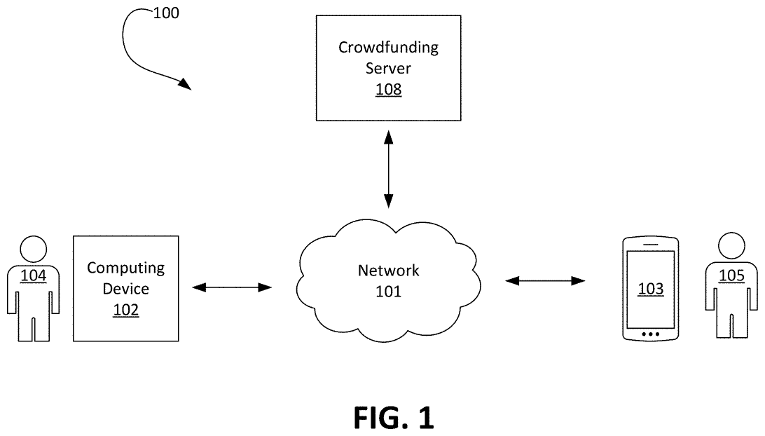

FIG. 1 is a crowdfunding system 100 in accordance with an embodiment of the present disclosure. The system comprises a crowdfunding server 108, a computing device 102 (an input device), and a handheld device 103 (an input device).

The computing device 102 communicates with the crowdfunding server 108 via the network 101. Further, the handheld device 103 communicates with the server 108 via the network 101. Note FIG. 1 shows the computing device 102 and the handheld device 103 as input devices. However, other crowdfunding systems may use other input devices in other embodiments.

In operation, there is an outcome clearly defined, e.g., the professional athlete signs with the new team. The professional athlete signing with the new team is the action that must occur for the funds collected from users or the funds pledged by the users 104 and/or 105 to go to the decision maker, e.g., the pro athlete.

Note that the decision maker can make the outcome occur. Hereinafter, the present disclosure may also refer to the outcome as a target, and the crowd fundraising may be referred to as a push or campaign. The Crowdfunding Entity creates a push or campaign to raise funds to provide to the decision maker once the decision maker achieves or promises the outcome. In effect, the Crowdfunding Entity serves as an escrow or facilitator for the contributed money to validate the outcome and disperse the money either to the decision maker or the users 104 and/or 105.

The server 108 generates a crowdfunding push or campaign. In this regard, the server 108 transmits data indicative of a push graphical user interface (GUI) (not shown) to the computing device 102 and/or the handheld device 103 via the network 101. The data indicative of the push GUI transmitted identifies an outcome, actions needed for the outcome to occur, and a decision maker. Further, the push GUI comprises a textbox wherein the user 104 and/or 105 may enter an amount of money to contribute to the push.

A push or campaign can last days or weeks. In one embodiment, if the decision maker has not decided by a particular date, the server 108 may terminate the push and return contributions to the users 104 and 105 or not collect money pledged by the users 104 and/or 105. If the decision maker decides to take action to accept an outcome defined in the push, and takes the action, e.g., signs a contract, the server 108 distributes the money held by the server 108 to the decision maker.

As an example, a sports fan base desires player X to sign with team Y (assuming team Y is willing to sign player X). The sports fan base organizes a push suited for this goal via their computing device 102 or their handheld device 103, which sets up a push on the server 108. Note that the push is intended to influence the player X's decision in free agency. The action is when player X signs with Team Y. Further, X is the decision maker. By setting up a push on server 108, the fan base raises social and financial support relating to the goal of player X signing with Team Y. If player X signs with team Y, the decision maker receives the money raised in the push. If not, the Crowdfunding Entity returns the money to the fan base contributors or does not collect money pledged by the fan base. Notably, the Crowdfunding Entity distributes the money to the decision maker on behalf of the push or campaign when the decision maker achieves the outcome.

As noted, a user 104 and/or 105 may define a push or campaign to influence decision makers to achieve a desired outcome that is beyond the user's normal sphere of capability to influence via recruiting like minded individuals or organizations to contribute social influence and money to the push. Alternatively, an individual administrator of the system 100 may define a push or campaign to influence decision makers to achieve a desired outcome.

Via the computing device 102 or the handheld device 103 a user 104 and/or 105 defines a desired outcome along with clear action points or enabling events. The server 108 stores the information defining the desired outcome along with the clear action points or enabling events. In addition, the user 104 and/or 105 identifies one or more decision makers (individuals or organizations) that can perform the action points and enable events to lead to the outcome. Further, the user communicatively couples his social media platform and a publicly accessible social media platform of a decision maker.

The server 108 broadcasts the defined push to its users 104 and/or 105 across an identified social media platform. The server 108 invites others to join the push and contribute money toward the outcome. That is, like-minded individuals and/or entities can contribute money and social influence for the push.

In one embodiment, the server 108 holds all monies contributed by the users 104 and/or 105 in escrow. Once the server 108 confirms an occurrence of an outcome, the server 108 transfers the monies contributed to the decision maker(s). If an outcome is impossible or deemed to have failed, the server 108 returns all monies back to the users 104 and/or 105.

In another embodiment, the server 108 stores data indicative of money pledge by a plurality of users in server memory. Once the server 108 confirms occurrence of an outcome, the server 108 collects the pledged money to be transferred to the decision maker. If an outcome is impossible or deemed to have failed, the server 108 does not collect the pledged money from the users 104 and/or 105.

Note that the discussion herein describes the money given by users 104 and/or 105 and a contribution. In another embodiment, the users 104 and/or 105 pledge money the outcome, and the users 104 and/or 105 contribute the money once the outcome is successful.

Further, FIG. 1 describes users 104 and/or 105. This is for exemplary purposes only. In one embodiment, there are a plurality of users each using his/her own computing device 102 or handheld device 103.

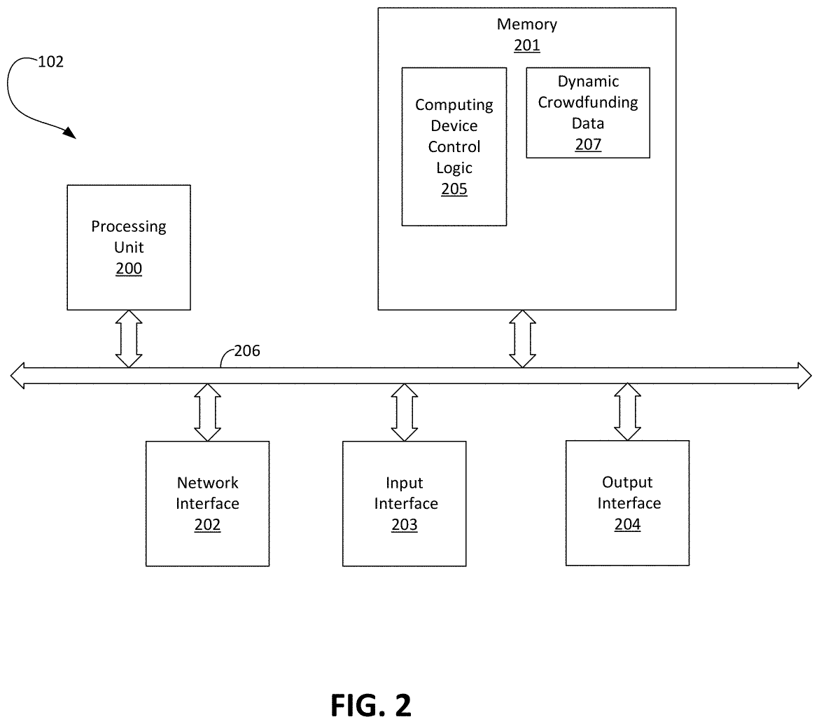

FIG. 2 is a block diagram of an exemplary embodiment of the computing device 102 depicted in FIG. 1. As shown by FIG. 2, the computing device 102 comprises at least a processing unit 200, a network interface 202, an input interface 203, an output interface 204, and memory 201. Stored in memory 201 is computing device control logic 205. The computing device control logic 205 may be software, hardware, firmware, or a combination thereof. Further, the computing device 102 comprises dynamic crowdfunding data 207.

The exemplary embodiment of the computing device 102 depicted by FIG. 2 comprises at least one conventional processing unit 200, such as a Digital Signal Processor (DSP) or a Central Processing Unit (CPU), that communicates to and drives the other elements within the computing device 102 via a local interface 206, which can include at least one bus. Further, the processing unit 200 is configured to execute instructions of software, such as the computing device control logic 205.

The computing device control logic 205 controls the functionality of the computing device 102, and the present disclosure provides a description in more detail hereafter. As noted above, the computing device control logic 205 may be implemented in software, hardware, firmware, or any combination thereof. In an exemplary embodiment illustrated in FIG. 2, the computing device control logic 205 is implemented in software and stored in memory 201.

Note that the computing device control logic 205, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The user 104 can input data via the input interface 203, for example, a touch screen, a keyboard, or a microphone of the computing device 102. In this regard, the user 104 may use the touch screen, keyboard, or microphone to provide input related to a push. Also, the input interface 203 may be a camera (not shown) that receives images, e.g., a photograph of a person initiating a push.

The user 104 can receive data via the output interface 204, for example, a display device (e.g., a Liquid Crystal Display (LCD)) of the computing device 102. In this regard, the computing device control logic 205 may display to the user GUIs configured to receive data related to a push to initiate the push.

In addition, the network interface 202, such as a Network Interface Card (NIC), enables the computing device 102 to communicate via the network 101 (FIG. 1) with the server 108.

The dynamic crowdfunding data 207 is data indicative of information received from the user 104 defining the push, including the outcome, the action items, and the decision maker. The dynamic crowdfunding data 207 may be any data indicative of selections by the user on a graphical user interface (GUI) displayed to the output interface 204. Notably, the computing device 102 transmits the dynamic crowdfunding data 207 to the server 108 via the network 101.

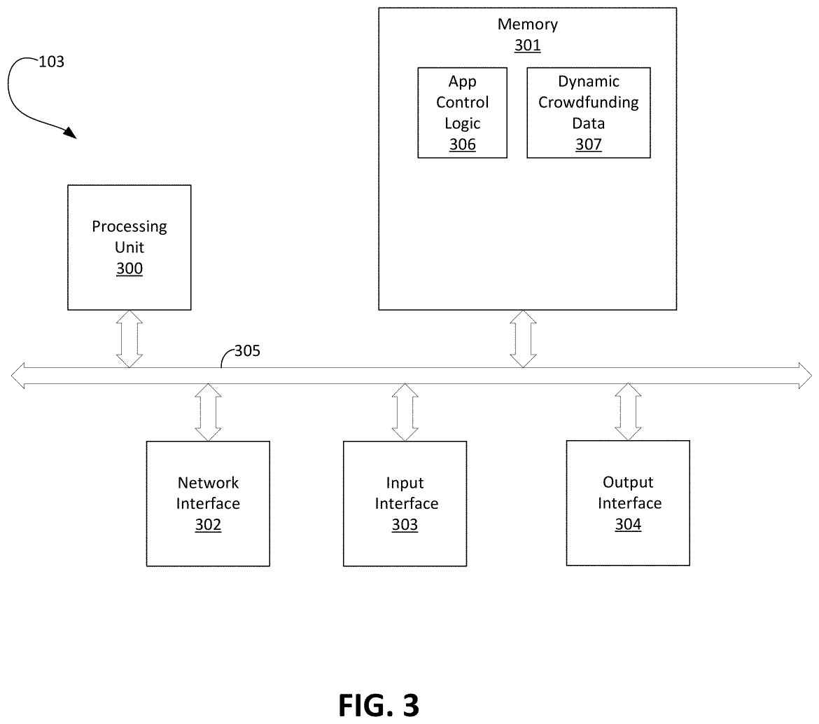

FIG. 3 is a block diagram of an exemplary embodiment of the handheld device 103 depicted in FIG. 1. As shown by FIG. 3, the handheld device 103 comprises at least a processing unit 300, a network interface 302, an input interface 303, an output interface 304, and memory 301. Stored in memory 301 is app control logic 306. The app control logic 306 may be software, hardware, firmware, or a combination thereof. Further, the handheld device 103 comprises dynamic crowdfunding data 307.

The exemplary embodiment of the handheld device 103 depicted by FIG. 3 comprises at least one conventional processing unit 300, such as a Digital Signal Processor (DSP) or a Central Processing Unit (CPU), that communicates to and drives the other elements within the handheld device 103 via a local interface 305, which can include at least one bus. Further, the processing unit 300 is configured to execute instructions of software, such as the app control logic 306.

The app control logic 306 controls the functionality of the handheld device 103, and the present disclosure will describe in more detail hereafter. As noted above, the app control logic 306 can be implemented in software, hardware, firmware, or any combination thereof. In an exemplary embodiment illustrated in FIG. 3, the app control logic 306 is implemented in software and stored in memory 301.

Note that the app control logic 306, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 303 may be, for example, a touch screen, a keyboard, or a microphone. The user 105 uses one or more of the input interfaces 303 to input data into the handheld device 103. In this regard, the user may use the touch screen, the keyboard or microphone to define a push. Also, the input device 303 may be a camera (not shown) that receives images, e.g., a photograph of the user 105.

The output interface 304, for example, a display device (e.g., a Liquid Crystal Display (LCD)), outputs data to the user 105 of the handheld device 103. In this regard, the app control logic 306 may display to the user GUIs configured to identify define a push, donate money, make a pledge, or simply monitor the status of a push.

In addition, the network interface 302, such as a Network Interface Card (NIC), enables the handheld device 103 to communicate via the network 101 (FIG. 1) with the server 108 (FIG. 1).

The dynamic crowdfunding data 307 is data indicative of information received from the user 105 regarding a push. The dynamic crowdfunding data 307 may be any data indicative of an outcome, actions, decision maker(s), etc. Memory 301 stores this dynamic crowdfunding data 307 until the app control logic 306 transmits the dynamic crowdfunding data 307 to the server 108.

In operation, the app control logic 306 displays a graphical user interface (GUI) to the output interface 304. The GUI comprises input icons (not shown) that receive data from the user 105 defining a push, which the app control logic 306 stores as dynamic crowdfunding data 307. Once the user enters this information, the app control logic 306 transmits data indicative of the push defined by the user to the server 108 (FIG. 1).

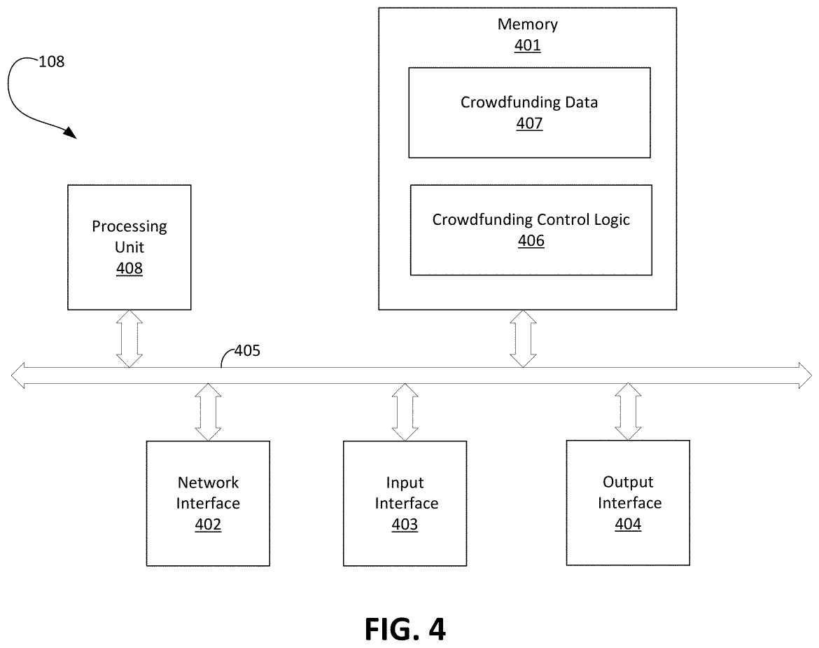

FIG. 4 is a block diagram of an exemplary embodiment of the crowdfunding server 108 depicted in FIG. 1. As shown by FIG. 4, the crowdfunding server 108 comprises a processing unit 400, a network interface 402, an input interface 403, an output interface 404, and memory 401. Stored in memory 401 is crowdfunding control logic 406. The crowdfunding control logic 406 may be software, hardware, firmware, or a combination thereof. Further, the crowdfunding server 108 comprises crowdfunding data 407.

The exemplary embodiment of the crowdfunding server 108 depicted by FIG. 4 comprises at least one conventional processing unit 408, such as a Digital Signal Processor (DSP) or a Central Processing Unit (CPU), that communicates to and drives the other elements within the crowdfunding server 108 via a local interface 405, which can include at least one bus. Further, the processing unit 408 executes instructions of software, such as the crowdfunding control logic 407.

The crowdfunding control logic 406 controls the functionality of the crowdfunding server 108, and the present disclosure will describe in more detail hereafter. As noted above, the crowdfunding control logic 406 may be implemented in software, hardware, firmware, or any combination thereof. In an exemplary embodiment illustrated in FIG. 4, the crowdfunding control logic 406 is implemented in software and stored in memory 401.

Note that the crowdfunding control logic 406, when implemented in software, the crowdfunding control logic 406 can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The input interface 403, for example, a keyboard, keypad, or mouse, can be used to input data from a support/maintenance user of the crowdfunding server 108, and an output interface 404, for example, a printer or display screen (e.g., a Liquid Crystal Display (LCD)), can be used to output data to a user of the crowdfunding server 108.

In addition, the network interface 402, such as a Network Interface Card (NIC), enables the crowdfunding server 108 to communicate via the network 101 (FIG. 1) with the handheld device 103 and the computing device 102.

The crowdfunding funding data 407 is any data related to a push(es). For example, the crowdfunding data 407 comprises is data indicative of outcome, actions related to the outcome, decision makers, money collected, and outcomes accomplished, or outcomes terminated. Inherently, the crowdfunding data 407 further comprises inputs received from users 104 and 105 (FIG. 1).

In operation, the crowdfunding control logic 406 receives data from a user 104 and/or 105 related to a push. The data received is indicative of an outcome defined along with clear action points or enabling events. In addition, the data includes information related to the decision makers that can perform the action points and enabling events to lead to the outcome. The user creating the push couples his/her social media platform with the publicly accessible social media platform of the decision maker.

Once the push is set up by the user 104 and/or 105, the crowdfunding control logic 406 broadcasts the push among its users and across identified social media platforms. The broadcast invites other users to join the platform and to contribute money. The crowdfunding control logic 406 transmits All contributions to an escrow account.

When an outcome that is subject of a push occurs, the crowdfunding control logic 406 transfers the contributions to the decision maker. When the crowdfunding control logic 406 determines that an outcome is impossible or the crowdfunding control logic 406 deems that the push has failed, the crowdfunding control logic 406 transfers money contributed to the users 104 and/or 105.

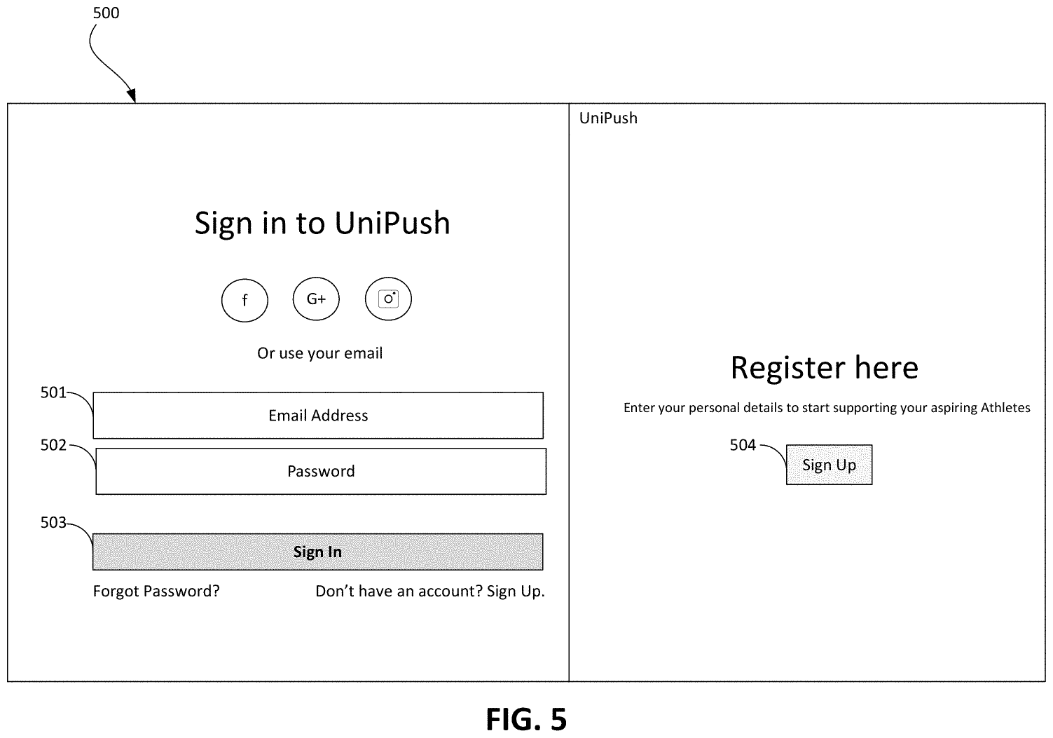

FIG. 5 is a registration and login graphical user interface (GUI) 500. The registration and login GUI 500 enables a user to sign up for or login for the crowdfunding system 100 (FIG. 1). The registration and login GUI 500 may be displayed to the computing device 102 (FIG. 1) or the registration and login GUI 500 may be displayed to the handheld device 103 (FIG. 1) via an app (software application) downloaded to the handheld device 103.

The user may sign into the crowdfunding system 100 using Facebook, Google plus, or Instagram. To login, the user enters his/her email address in text box 501 and a password in text box 501 and select the sign in pushbutton 503 to sign into the crowdfunding system 100. If the user does not already have an account on the crowdfunding system 100, the user can select the sign up pushbutton 504, which will display a GUI (not shown) where the user enters his/her personal information.

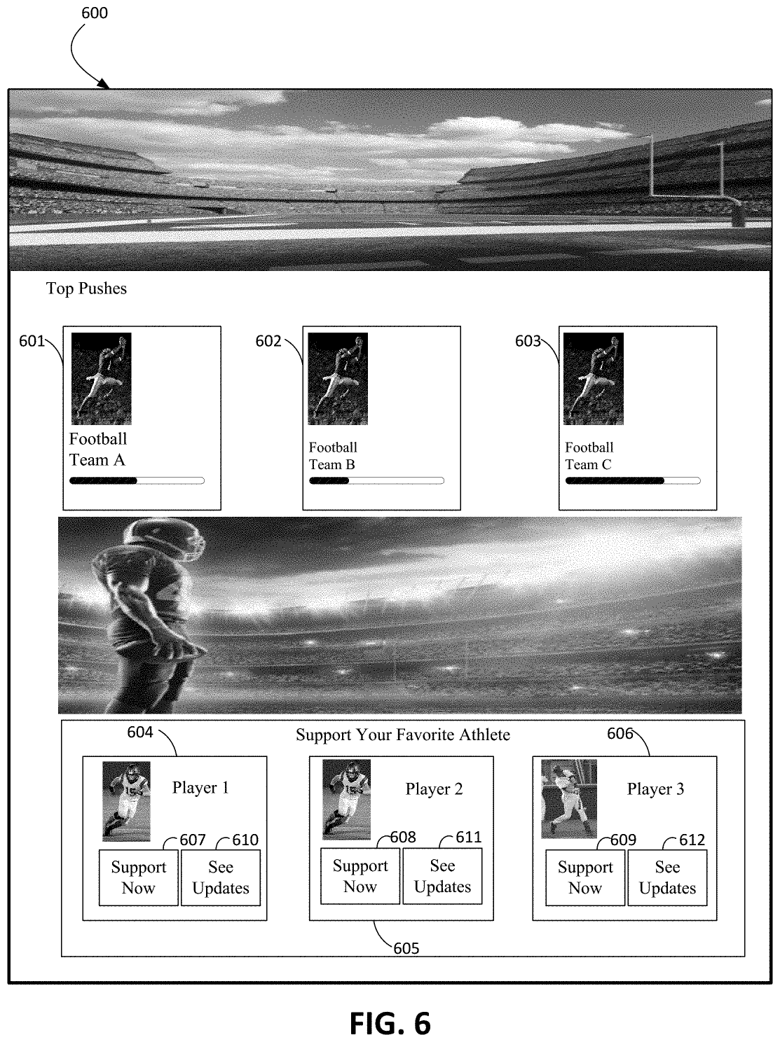

Once a user logs into the crowdfunding system 100, a main GUI 600 shown in FIG. 6 is displayed to the computing device 102 or the handheld device 103. The main GUI 600 comprises a plurality of pushes 601-603. Note that a push is simply a campaign that is defined by a specific goal such that is goal is achieved, a third party is awarded monies raised during the campaign, but if the goal is not achieved, the monies return to the users.

In GUI 600 there are three top pushes including a university 1 Football push 601, a University Football 2 push 602, and a 3 Football push 603. By selecting one of the pushes 601-603, the user may learn more about the push and donate money to the push.

The user may also support their favorite athlete. In this regard, there are boxes. There is a box 604 for Professional 1, a box 605 for Professional 2, and a box 606 for Professional 3. If the user selects to support the athlete, he/she selects the support now button 607-609 and a GUI (not shown) is displayed that enables the user to donate money or other support to his/her favorite player. Also, the user may see updates about their favorite player via see updates buttons 610-612.

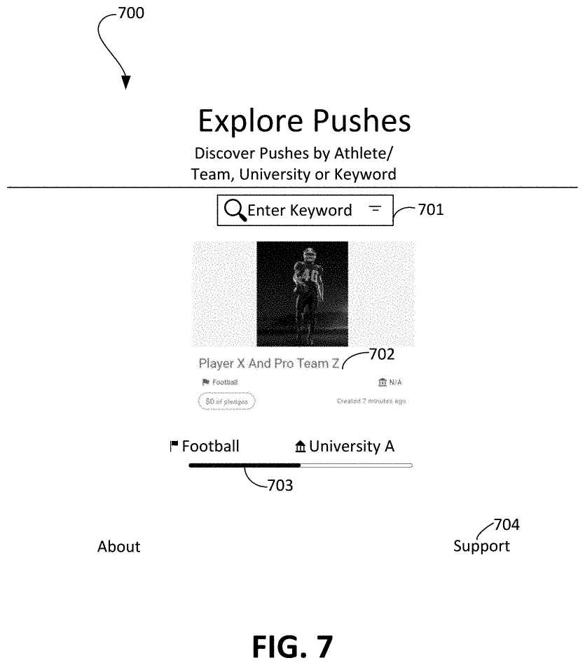

FIG. 7 is an entity and/or individual push page GUI 700. With the individual push page GUI 700, an individual can search for pushes and support a push.

In this regard, the individual push page GUI 700 comprises an enter keyword text box 701. In response, the system 100 displays a plurality of pushes that relate to the word entered in the keyword text box 701. The user can search for a push by entering data in the enter keyword textbox 7, and when the system 100 displays the plurality of pushes, the user can select a push to support or review.

Further, the individual push page GUI 700 comprises an action statement 702. In the individual push page GUI 700, the action is “Player X Joins Professional Team Y.” This this is the goal of the push. That is, if player x joins Professional Team y, the player X (decision maker) receives money collected from the push campaign.

In the exemplary example shown in FIG. 7, the goal relates to the University 1 football team, and the dynamic progress bar 703 shows how much money has been collected to support the published push, i.e., player x signs with team y.

Further, there is a support pushbutton 704. When selected, a GUI (not shown) is displayed in which the user can use his/her payment information to donate money to the push. As money is donated to the push, the dynamic progress bar 703 continues to show an increase in money pledged to the goal.

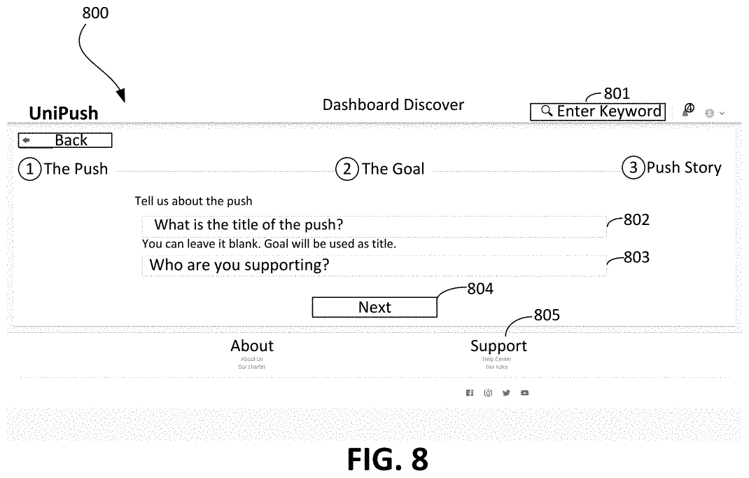

FIGS. 8-11 illustrate an exemplary manner a push could be created. FIG. 8 is a define push GUI 800, and the page is entitled “Dashboard Discover.” There is a search text box 801 in which a user can enter a keyword to search for a particular push.

The define push GUI 800 comprises a text box 802 in which the user enters data indicative of a title of the push. If this text box is left blank the system 100 uses the goal defined as the titled.

The define push GUI 800 comprises a textbox 803 in which the user enters the person/entity that he/she is supporting. If the user desires to support a person and/or and entity, he/she may select support button 805. When selected, a GUI (not shown) is displayed in which the user can use his/her payment information to donate money to the push.

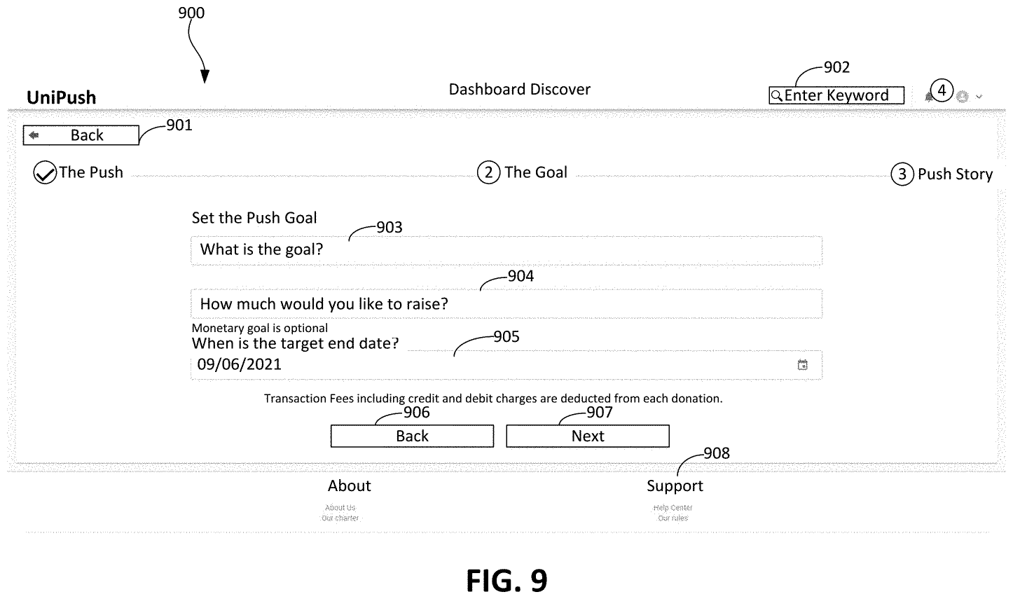

When the user has completed the define push GUI 800, the user selects the next pushbutton 804, and the system 100 displays a goal GUI 900 of FIG. 9.

The goal GUI 900 of FIG. 9 comprises a back pushbutton 901 that displays GUI 800 (FIG. 8) if the user desires to change information contained in the GUI 800. The goal GUI 900 comprises a search text box 902, so that the user can search for existing searches.

The goal GUI 900 further comprises a text box 903 where the user enters data defining and indicative of what the goal is of the push. Thus, the user enters text box 903 the goal of the push, e.g., player x joins team y.

The goal GUI 900 further comprises a text box 904 where the user enters data defining and indicative of how much the user desires to raise in the push, the user enters an end date for the push in text box 904.

In matriculating the GUIs, the goal GUI 900 comprises a back pushbutton 906 wherein the user can select and the system 100 takes the user back to GUI 800. There is also a next pushbutton 907 wherein the user can select and the system 100 takes the user to the next GUI 1000.

Further, the goal GUI 900 comprises a support pushbutton 908. When selected, a GUI (not shown) is displayed in which the user can use his/her payment information to donate money to the push.

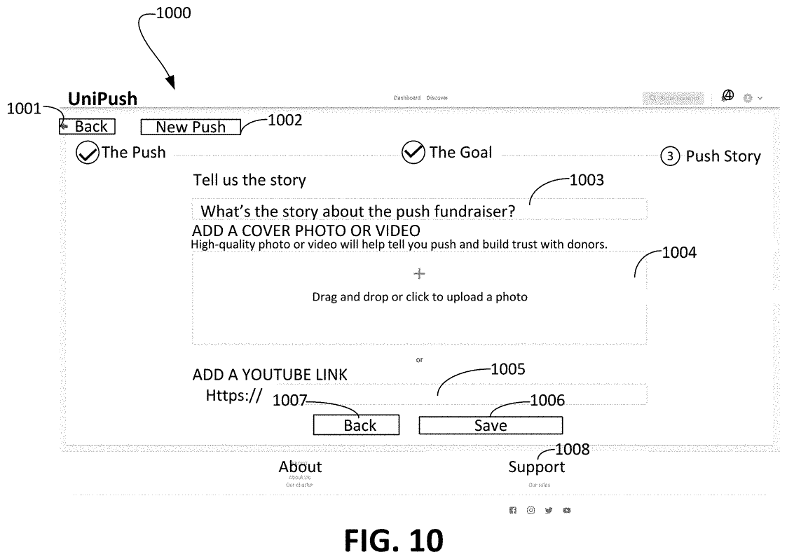

FIG. 10 is a push story GUI 1000 displayed to the computing device 102 (FIG. 1) or the handheld device 103 (FIG. 1). The push story GUI 1000 has a back button 1001 that when selected, takes the user back to GUI. 900. Further, the push story GUI 1000 has a new push button 1002 that when selected, takes the user back to FIG. 800 to start a new push.

The push story GUI 1000 comprises a textbox 1003 in which a user may enter data indicative of what the story is about relating to the push fundraiser. Further, the push story GUI 1000 comprises an upload photo or image box 1004 so that the user can enter a photo or video related to the push defined. Also, there is a textbox wherein a user can enter data indicative of a YouTube video.

To matriculate the numerous GUIs of the system 100, the GUI 1000 comprises a back pushbutton 1007 that when selected displays the GUI 900 (FIG. 9). Further, the GUI 1000 comprises a save pushbutton 1006 that when selected saves the push as defined in FIGS. 8-10.

The push story GUI 1000 further comprises a support pushbutton 1006. Further, the push story GUI 1000 comprises a support pushbutton 1006. When selected, a GUI (not shown) is displayed in which the user can use his/her payment information to donate money to the push.

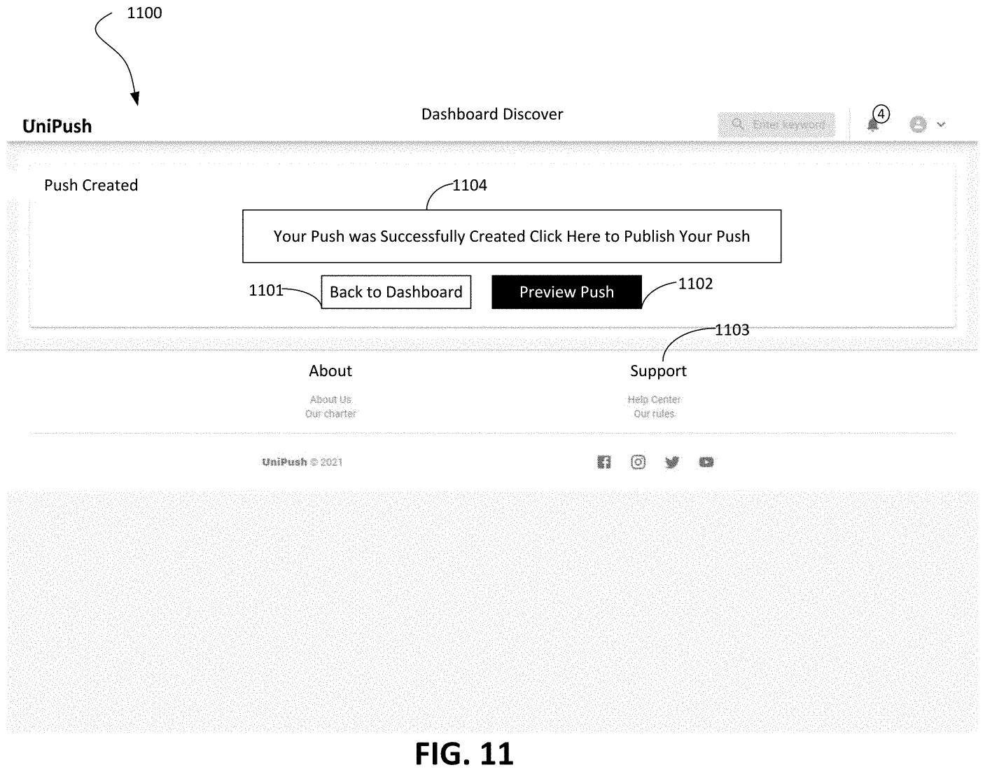

Once the user has successfully defined a push, the system 100 displays the success GUI 1100 as is shown in FIG. 11. The success GUI 100 comprises a pushbutton 1104 that states “Your Push was Successfully Created Click Here to Publish you Push.” Thus, when the pushbutton 1104 is selected, the newly defined push is made available to the public.

Pushbutton 1101, when selected, matriculates the user back to the Dashboard. Further, the user can preview his/her push by selecting preview push pushbutton 1102. In addition, the success GUI 1100 comprises a support pushbutton 1103. When selected, a GUI (not shown) is displayed in which the user can use his/her payment information to donate money to the push.

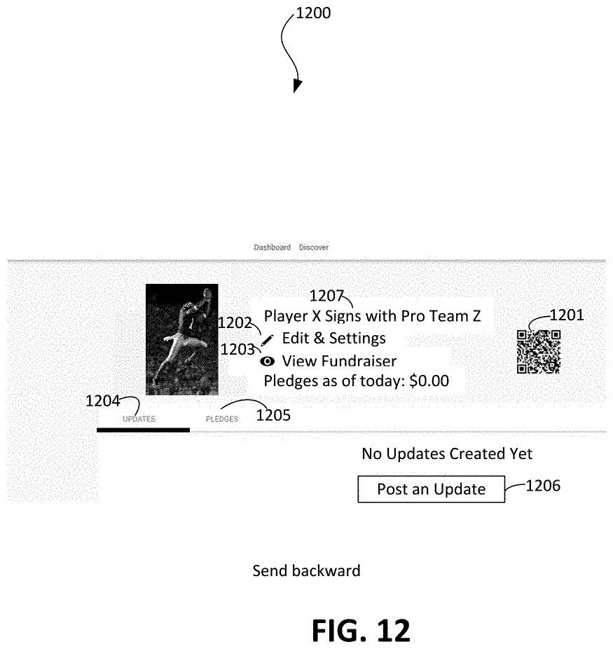

When the user selects preview push 1102 (FIG. 11), the system 100 displays the preview push GUI 1200 shown in FIG. 12. The preview push GUI 1200 provides the information in a GUI related to the information entered in GUIS. 8-11.

In this regard, the preview push GUI 1200 comprises a goal 1207 for the push. The goal is a statement that defines the push. The preview push GUI 1200 further displays pledge pushbutton 1205, which a user may select and donate money to the push.

Also, the preview push GUI 1200 comprises a follow pushbutton Q-cod 1201. When scanned, the computing device 102 or the handheld device 103 displays details about the push.

Further, a user may select edit & Settings 1202 to make edits to his/her account. Also, the user may select View Fundraiser to view the details of the money accumulated om the push.

The user may select the UPDATES link 1204, and updates to the push are displayed to the user. In addition, the user may select Post an Update pushbutton 1206 to enter an update related to the push.

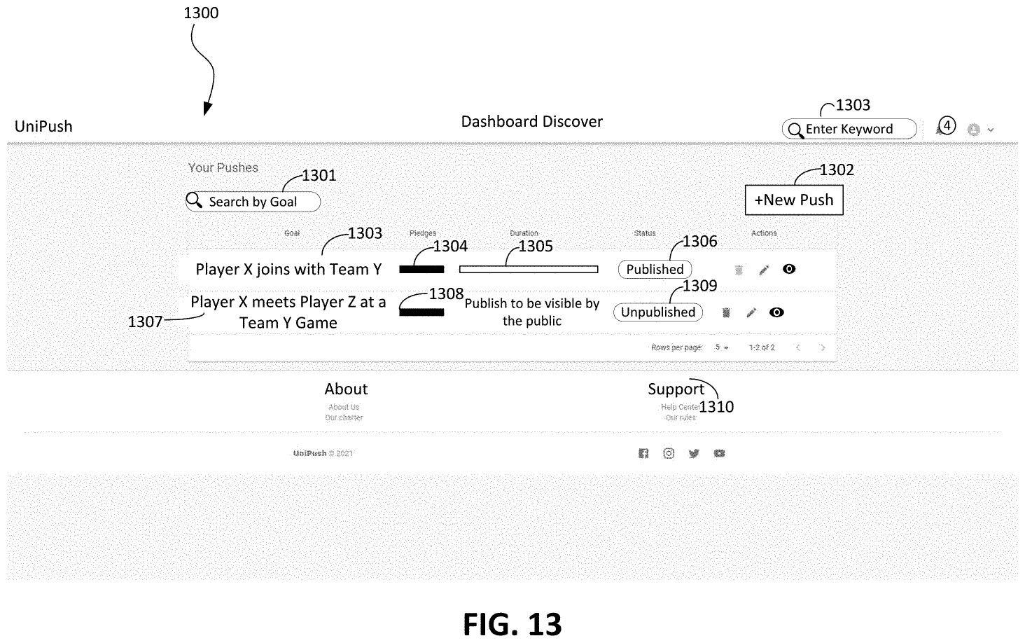

FIG. 13 is an administrative GUI 1300 that displays all the pushes that have not yet expired. A pushbutton 1301, when selected, searches the push data by goal. Also, the user may search for keywords related to a push using text box 1303. Further, a user can begin a new push by selecting pushbutton 1302.

The system 100 displays a list of active pushes. In this regard “Player X Joins with Team Y” 1303 is a defined push. A dynamic progress bar 1304 indicates the amount of money raised thus far. The dynamic progress bar 1305 indicates a duration of the push, and an indicator 1306 indicates whether the push is published or nonpublished. With respect to defined push 01303, the GUI 1300 indicates that it is published.

Further “Play A joins player B at the Professional Team C” 1307 is a defined push. A dynamic progress bar 1308 indicates the amount of money raised thus far toward the goal of the push. This push is not published, as indicated by text 1309. Thus, there is no duration associated with the push.

Further, there is a support pushbutton 1310. When selected, a GUI (not shown) is displayed in which the user can use his/her payment information to donate money to the push. As money is donated to the push, the dynamic progress bars 1304 and 1308 continue showing an increase in money pledged to the goal.

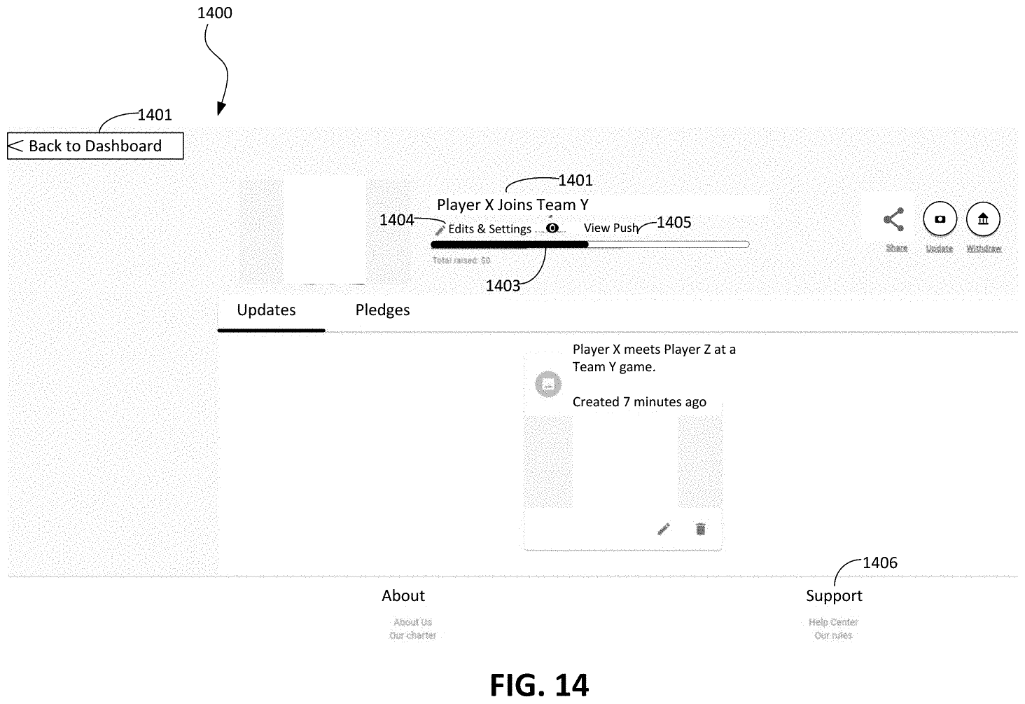

FIG. 14 is a goal met GUI 1400. In this regard, the goal as defined was “Play A joins Player B at Team C” 1402. The dynamic progress bar 1403 indicates how much money was raised toward the goal defined.

From the goal met GUI 1400, the user can select “Edits & Settings” and edit his/her account information or the details of the push. Further, the user may select “View Push” 1405, and the system 100 displays details of the push.

Further, there is a support pushbutton 1406. When selected, a GUI (not shown) is displayed in which the user can use his/her payment information to donate money to the push. As money is donated to the push, the dynamic progress bar 1403 continues to show an increase in money pledged to the goal.

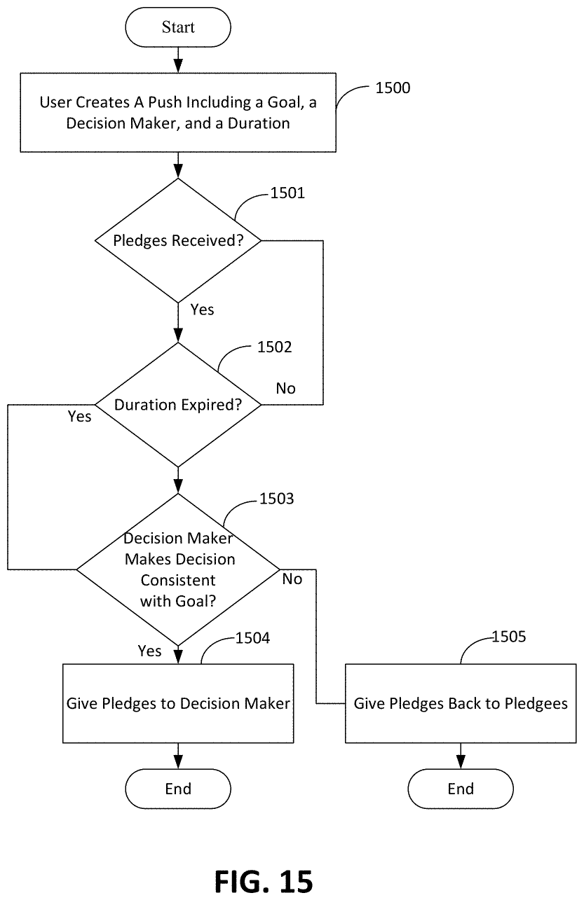

FIG. 15 is a flowchart exhibiting exemplary architecture and functionality of an embodiment of the system 100 (FIG. 1).

In step 1500 an individual creates a push. The individual may be a user of the computing device 102 (FIG. 1) or the handheld device 103 (FIG. 1). Also, an administrator of the server 108 may create a push. A push comprises the following: 1) a Goal; 2) a decision maker; and 3) a duration. Optionally, the individual may divulge information like a story related to the push, a photograph related to the push, or a YouTube video related to the push.

In step 1501, pledges may be received from the public or individuals who have access to the push data. The server 108 (FIG. 1) performs the financial transactions and stores the pledges received in escrow. In step 1501, the system 100 continues to receive pledges until the duration has expired in step 1502 or if the decision maker's decision consistent with the goal in step 1503.

If the decision maker's decision is consistent with the goal in step 1503, the pledges collected during the push are awarded to the decision maker in step 1504. If not, the pledges collected are returned to the pledgees.

Note that throughout the present disclosure the term user is used. The term user may refer to an individual or user may refer to an entity.

1. A system, comprising:
one or more display devices configured for displaying graphical user interfaces (GUI) to a user;
a processor communicatively coupled to the one or more display devices via a network, the processor configured for receiving data from the GUIs indicative of a goal and a decision maker from an entity, the decision maker having the capacity to obtain the goal, the processor further configured for receiving pledges and/or money from a plurality of users that desire to support the goal, the processor further configured to award the decision maker the pledges and/or money if the goal is met.

2. The system of claim 1, wherein if the goal is not met or the duration expires, the processor is configured to refund the pledgees their respective monetary pledges.

3. The system of claim 1, further comprising a server.

4. The system of claim 1, wherein the server comprises memory for storing data indicative of a plurality of pushes.

5. The system of claim 1, wherein the money received from the plurality of entities is stored in escrow.

6. The system of claim 1, wherein the server houses the processor.

7. The system of claim 1, wherein the display device is a computing device.

8. The system of claim 1, wherein the individuals are users of the display devices.

9. The system of claim 1, wherein the individuals are administrators of a server that receives push data from users.

10. The system of claim 1, further comprising a main GUI that lists a plurality of active pushes.

11. The system of claim 10, wherein the user selects one of the plurality of active pushes to pledge money to one of the plurality of active pushes.

12. The system of claim 10, wherein the user selects one of an athlete and/or a team to which to pledge money.

13. The system of claim 10, wherein the user selects one of an athlete and/or a team to which the user gives money.

14. The system of claim 10, further comprising a GUI that enables the user to search for a particular push and pledge money to the push found.

15. The system of claim 1, wherein data indicative of the plurality of pledges received from the plurality of individuals is stored in memory on a server.

16. A method, comprising:
displaying graphical user interfaces (GUI) to a user via one or more display devices;
receiving, by a processor from an individual, data from the GUIs indicative of a goal and a decision maker, the decision maker having the capacity to obtain the goal;
receiving, by the processor, pledges from a plurality of users that desire to support the goal;
awarding the decision maker, the pledges if the goal is met.

17. The method of claim 16, wherein if the goal is not met or the duration expires, the processor refunds the pledgees their respective monetary pledges.

18. The method of claim 16, wherein the server comprises memory for storing data indicative of a plurality of pushes.

19. The method of claim 16, further comprising storing, by the processor, the pledges received in escrow.

20. The method of claim 16, further comprising receiving, by the processor, push data from a computing device.

21. The system of claim 16, further comprising listing a plurality of active pushes on a main GUI.

22. The method of claim 21, further comprising selecting by the user one of the plurality of active pushes to pledge money to one of the plurality of active pushes.

23. The method of claim 22, further comprising selecting one of an athlete and/or a team.

24. The method of claim 22, further comprising the user pledging money to the athlete and/or the team.

24. The method of claim 24, further comprising searching a GUI for a particular push and pledging money to the push found.
